(19) United States
(12) Patent Application Publication
(10) Pub. No.: US 2025/0118022 A1
(43) Pub. Date: Apr. 10, 2025

(54) MULTI-USER PROMPTS FOR GENERATIVE ARTIFICIAL INTELLIGENCE SYSTEMS

(71) Applicant: AUTODESK, INC., San Francisco, CA (US)

(72) Inventors: George William FITZMAURICE, Toronto (CA); Jo Karel VERMEULEN, East York (CA); Justin Frank MATEJKA, Newmarket (CA)

(21) Appl. No.: 18/765,122

(22) Filed: Jul. 5, 2024

Related U.S. Application Data
(60) Provisional application No. 63/588,657, filed on Oct. 6, 2023.

(51) Int. Cl. G06T 17/10; G06T 19/00

(52) U.S. Cl. CPC G06T 17/10; G06T 19/00; G06T 2200/04; G06T 2200/24; G06T 2219/024

(57) ABSTRACT

In various embodiments, a computer-implemented method for generating digital content comprises generating a multiparty interface that communicates with at least a trained machine learning (ML) model, a first client device, and a second client device; combining at least a first input from the first client device and a second input from the second client device to generate a composite prompt, transmitting the composite prompt to the trained ML model for execution, receiving a digital content item from the trained ML model that was generated in response to the composite prompt, and displaying the digital content item in the multiparty interface.

### CROSS-REFERENCE TO RELATED APPLICATIONS

This application claims priority benefit of the United States Provisional Patent Application titled “TECHNIQUES FOR ENABLING MULTIPLE USERS TO CONTRIBUTE TO ONE OR MORE GENERATIVE ARTIFICIAL INTELLIGENCE SYSTEMS,” filed on Oct. 6, 2023, and having Ser. No. 63/588,657. The subject matter of this related application is hereby incorporated herein by reference.

### BACKGROUND

### Field of the Various Embodiments

The various embodiments relate generally to computer-aided design and artificial intelligence and, more specifically, to multi-user prompts for generative artificial intelligence systems.

### Description of the Related Art

Designers interact with various types of digital content creation (DCC) applications to create various types of content, including, and without limitation, text, images, videos, and designs, such as three-dimensional (3D) objects. During the creation of digital content, a user generally proceeds through a rapid generation and exploration process, where the user explores various avenues to create content that meets various design goals. For example, a poet may list various keywords, synonyms, antonyms, and rhyming terms when drafting an initial version of a poem. Similarly, an artist may apply varying sketching techniques to draft an illustration in varying artistic styles before selecting a specific artistic style to complete the illustration. During the design exploration phase for 3D objects, a designer usually generates and evaluates various design alternatives for one or more 3D objects within a larger 3D design project. As is well-understood, manually generating multiple designs for even a relatively simple 3D object can be very labor-intensive and time-consuming.

To address the above issues associated with the design exploration phase for 3D objects, various conventional computer-aided design (CAD) applications have been developed that implement an artificial intelligence (AI) model, such as a generative machine learning (ML) model, to automatically synthesize 3D objects in response to prompts provided by a user. In operation, the AI model responds to a given prompt by executing various optimization algorithms to generate 3D object designs that satisfy one or more design characteristics specified by the user in the prompt. In some cases, the AI model generates a single 3D object design that the user then incorporates into the larger 3D design project. In other cases, the AI model generates numerous alternative 3D object designs and presents those alternatives to the user for evaluation and selection.

One drawback of the above approach is that conventional CAD applications that implement AI models do not effectively facilitate communications between the AI model and a group of multiple users. In this regard, a conventional CAD application typically focuses on one-on-one interactions between the AI model and a single user. In doing so, the conventional CAD application normally provides an interface that allows a single user to input prompts for the AI model, and the AI model generates outputs that are responsive to the prompts. Notably, though, these types of conventional interfaces do not provide a practical way for multiple users to communicate with both the AI model and other users. Consequently, when multiple users are working together on a given 3D design project, the different users are forced to interact with each other using a separate communication channel, such as a multi-user chat service or an email thread, in order to generate prompts for the AI model.

Oftentimes, one of the users has to distill the different goals and inputs those prompts into the AI model during a one-on-one session. This process frequently results in prompts that do not capture and include the full range of information that the different users in the group wanted to provide to the AI model. In particular, the one user responsible for generating the prompts may not properly incorporate the goals and constraints articulated by the collective group of users into the different prompts. Consequently, the prompts may not reflect ideas and intents of the collective group of users with respect to various 3D object designs. Without accurate prompts, the AI model cannot generate 3D objects that accurately reflect the ideas and intents of the collective group of users, which can substantially reduce overall design quality and inhibit the exploration of the overall design space.

As the foregoing illustrates, what is needed in the art are more effective techniques for automatically generating designs using artificial intelligence models.

### SUMMARY

In various embodiments, a computer-implemented method for generating digital content comprises generating a multiparty interface that communicates with at least a trained machine learning (ML) model, a first client device, and a second client device; combining at least a first input from the first client device and a second input from the second client device to generate a composite prompt, transmitting the composite prompt to the trained ML model for execution, receiving a digital content item from the trained ML model that was generated in response to the composite prompt, and displaying the digital content item in the multiparty interface.

At least one technical advantage of the disclosed techniques relative to the prior art is that the disclosed techniques enable a CAD application to collect and aggregate inputs from multiple different users in a user group when generating prompts, which allows an AI system to understand the collective ideas and intents of the user group more accurately and generate digital content that more accurately reflects those collective ideas and intents. In that regard, the disclosed techniques provide an automated process for collecting a plurality of prompts generated from multiple users in a shared interface and weighing the different prompts before transmitting the prompts to the AI model for execution. Collecting and weighing multiple prompts used as inputs to the AI model enables group members to clarify the collective ideas and intents of the group by emphasizing specific ideas and goals. Accordingly, the disclosed techniques enable the AI model to better infer the ideas and intents of the group of users and generate digital content that is more reflective of those ideas and intents. Accordingly, the disclosed techniques enable a group of users to generate digital content using a CAD application that aligns better with the actual ideas and intents of the group without requiring coordination between group members using a separate communication channel. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments;

FIG. 2 is a more detailed illustration of the design exploration application of FIG. 1, according to various embodiments;

FIG. 3 is an exemplar illustration of a multi-user system including the intent management application of FIG. 2, according to various embodiments;

FIG. 4 is an exemplar illustration of the multiparty interface of FIG. 3, according to various embodiments;

FIG. 5 is an exemplar illustration of another multiparty interface of FIG. 3, according to various other embodiments;

FIG. 6A is an exemplar illustration of a weighting interface implemented by the intent management application of FIG. 3, according to various embodiments;

FIG. 6B is an exemplar illustration of another weighting interface implemented by the intent management application of FIG. 3, according to various other embodiments;

FIG. 7 sets forth a flow diagram of method steps for generating digital content items, according to various embodiments; and

FIG. 8 depicts one architecture of a system within which embodiments of the present disclosure may be implemented.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances of like objects are symbolized with reference numbers identifying the object and parenthetical numbers(s) identifying the instance where needed.

### System Overview

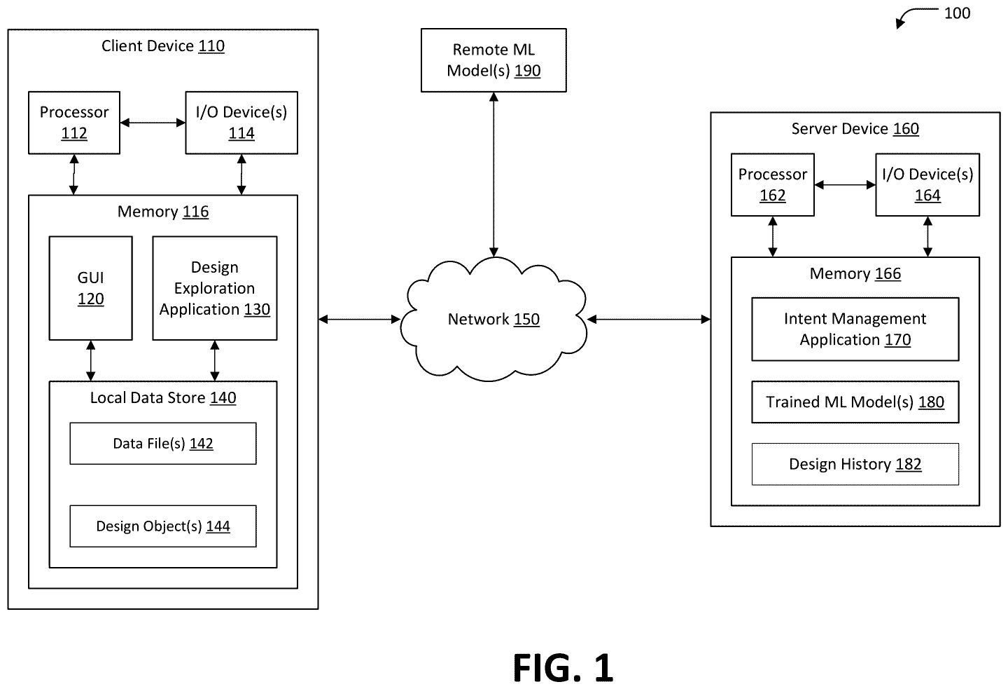

FIG. 1 is a conceptual illustration of a system 100 configured to implement one or more aspects of the various embodiments. As shown, in some embodiments, the system 100 includes, without limitation, a client device 110, a server device 160, and one or more remote machine learning (ML) models 190. The client device 110 includes, without limitation, a processor 112, one or more input/output (I/O) devices 114, and a memory 116. The memory 116 includes, without limitation, a graphical user interface (GUI) 120, a design exploration application 130, and a local data store 140. The local data store 140 includes, without limitation, one or more data files 142 and one or more design objects 144. The server device 160 includes, without limitation, a processor 162, one or more I/O devices 164, and a memory 166. The memory 166 includes, without limitation, an intent management application 170, one or more trained ML models 180, and design history 182. In some other embodiments, the system 100 can include any number and/or types of other client devices, server devices, remote ML models, or any combination thereof.

Any number of the components of the system 100 can be distributed across multiple geographic locations or implemented in one or more cloud computing environments (e.g., encapsulated shared resources, software, data) in any combination. In some embodiments, the client device 110 and/or zero or more other client devices (not shown) can be implemented as one or more compute instances in a cloud computing environment, implemented as part of any other distributed computing environment, or implemented in a stand-alone fashion. In various embodiments, the client device 110 can be integrated with any number and/or types of other devices (e.g., one or more other compute instances and/or a display device) into a user device. Some examples of user devices include, without limitation, desktop computers, laptops, smartphones, and tablets.

In general, the client device 110 is configured to implement one or more software applications. For explanatory purposes only, each software application is described as residing in the memory 116 of the client device 110 and executing on the processor 112 of the client device 110. In some embodiments, any number of instances of any number of software applications can reside in the memory 116 and any number of other memories associated with any number of other compute instances and execute on the processor 112 of the client device 110 and any number of other processors associated with any number of other compute instances in any combination. In the same or other embodiments, the functionality of any number of software applications can be distributed across any number of other software applications that reside in the memory 116 and any number of other memories associated with any number of other compute instances and execute on the processor 112 and any number of other processors associated with any number of other compute instances in any combination. Further, subsets of the functionality of multiple software applications can be consolidated into a single software application.

In particular, the client device 110 is configured to implement a design exploration application 130 to generate designs for one or more 3D objects. In operation, the design exploration application 130 causes one or more ML models 180, 190 to synthesize designs for a 3D object based on any number of goals and constraints. The design exploration application 130 then presents the designs as one or more design objects 144 to a user in the context of a design space. In some embodiments, the user can explore and modify the one or more design objects via the GUI 120. Additionally or alternatively, the user can also include at least one of the design objects 144 for use in additional design and/or manufacturing activities.

In various embodiments, the processor 112 can be any instruction execution system, apparatus, or device capable of executing instructions. For example, the processor 112 could comprise a central processing unit (CPU), a digital signal processing unit (DSP), a microprocessor, an application-specific integrated circuit (ASIC), a neural processing unit (NPU), a graphics processing unit (GPU), a field-programmable gate array (FPGA), a controller, a microcontroller, a state machine, or any combination thereof. In some embodiments, the processor 112 is a programmable processor that executes program instructions to manipulate input data. In some embodiments, the processor 112 can include any number of processing cores, memories, and other modules for facilitating program execution.

The input/output (I/O) devices 114 include devices configured to receive input, including, for example, a keyboard, a mouse, and so forth. In some embodiments, the I/O devices 114 also includes devices configured to provide output, including, for example, a display device, a speaker, and so forth. Additionally or alternatively, the I/O devices 114 may further include devices configured to both receive and provide input and output, respectively, including, for example, a touchscreen, a universal serial bus (USB) port, and so forth.

The memory 116 includes a memory module, or collection of memory modules. In some embodiments, the memory 116 can include a variety of computer-readable media selected for their size, relative performance, or other capabilities: volatile and/or non-volatile media, removable and/or non-removable media, etc. The memory 116 can include cache, random access memory (RAM), storage, etc. The memory 116 can include one or more discrete memory modules, such as dynamic RAM (DRAM) dual inline memory modules (DIMMs). Of course, various memory chips, bandwidths, and form factors may alternately be selected. The memory 116 stores content, such as software applications and data, for use by the processor 112. In some embodiments, a storage (not shown) supplements or replaces the memory 116. The storage can include any number and type of external memories that are accessible to the processor 112 of the client device 110. For example, and without limitation, the storage can include a Secure Digital (SD) Card, an external Flash memory, a portable compact disc read-only memory, an optical storage device, a magnetic storage device, or any suitable combination of the foregoing.

Non-volatile memory included in the memory 116 generally stores one or more application programs including the design exploration application 130, and data (e.g., the data files 142 and/or the design objects stored in the local data store 140) for processing by the processor 112. In various embodiments, the memory 116 can include non-volatile memory, such as optical drives, magnetic drives, flash drives, or other storage. In some embodiments, separate data stores, such as one or more external data stores connected via the network 150 (“cloud storage”) can supplement the memory 116. In various embodiments, the design exploration application 130 within the memory 116 can be executed by the processor 112 to implement the overall functionality of the client device 110 to coordinate the operation of the system 100 as a whole.

In various embodiments, the memory 116 can include one or more modules for performing various functions or techniques described herein. In some embodiments, one or more of the modules and/or applications included in the memory 116 may be implemented locally on the client device 110, and/or may be implemented via a cloud-based architecture. For example, any of the modules and/or applications included in the memory 116 could be executed on a remote device (e.g., smartphone, a server system, a cloud computing platform, etc.) that communicates with the client device 110 via a network interface or an I/O devices interface.

The design exploration application 130 resides in the memory 116 and executes on the processor 112 of the client device 110. The design exploration application 130 interacts with a user via the GUI 120. In some embodiments, the design exploration application 130 and one or more separate applications (not shown) interact with the same user via the GUI 120. In various embodiments, the design exploration application 130 operates as a 3D design application to generate and modify an overall 3D design that includes one or more design objects 144. The design exploration application 130 interacts with a user via the GUI 120 in order to generate the one or more design objects 144 via direct user input (e.g., one or more tools to generate 3D objects, wireframe geometries, meshes, etc.) or via separate devices (e.g., the trained ML models 180, the remote ML models 190, separate 3D design applications, etc.). When generating the one or more design objects 144 via separate devices, the design exploration application 130 generates a prompt that effectively describes design-related intentions using one or more modalities (e.g., text, speech, images, etc.). The design exploration application 130 then causes the one or more of the ML models 180, 190 to operate on the generated prompt to generate a relevant design object 144. The design exploration application 130 receives the design object 144 from the one or more ML models 180, 190 and displays the design object 144 within the GUI 120. The user can select via the GUI 120 the design object 144 for use, such as incorporating the design object 144 in a larger 3D design.

In some embodiments, the design exploration application 130 can operate as another type of digital content creation (DCC) application. For example, the design exploration application 130 can operate as an image editor to generate and modify 2D or 3D images. In another example, the design exploration application 130 can operate as a video editor application that generates and modifies audiovisual content. When the design exploration application is operating as a DCC application, the design exploration application 130 interacts with a user via the GUI 120 in order to generate the one or more content items directly or via the ML models 180, 190. When generating content items via the ML models 180, 190, the design exploration application 130 generates a prompt that effectively describes design-related intentions for specific type of digital content item that is to be generated (e.g., describing aspects of a 2D image or sketch). The design exploration application 130 thus can generate various types of digital content items including, without limitation, a text, a computer-aided design (CAD) object, a geometry, an image, a sketch, a video, executable code, or an audio recording.

The GUI 120 can be any type of user interface that allows users to interact with one or more software applications via any number and/or types of GUI elements. The GUI 120 can be displayed in any technically feasible fashion on any number and/or types of stand-alone display device, any number and/or types of display screens that are integrated into any number and/or types of user devices, or any combination thereof. The design exploration application 130 can perform any number and/or types of operations to directly and/or indirectly display and monitor any number and/or types of interactive GUI elements and/or any number and/or types of non-interactive GUI elements within the GUI 120. In some embodiments, each interactive GUI element enables one or more types of user interactions that automatically trigger corresponding user events. Some examples of types of interactive GUI elements include, without limitation, scroll bars, buttons, text entry boxes, drop-down lists, and sliders. In some embodiments, the design exploration application 130 organizes GUI elements into one or more container GUI elements (e.g., panels and/or panes).

In some embodiments, the GUI 120 includes one or more communications channels with one or more other devices and/or entities. For example, the design exploration application 130 can include a communication channel with the trained ML model 180 via the intent management application 170. As will be discussed in further detail below, the communication channel can be established between two or more client devices 110 (e.g., 110(1), . . . 110(X)) and one or more ML models 180 (e.g., 180(1), . . . 180(Y)) and/or one or more remote ML models 190 (e.g., 190(1), . . . 190(Z)).

The local data store 140 is a part of storage in the client device 110 that stores one or more design objects 144 included in an overall 3D design and/or one or more data files 142 associated with 3D design. For example, an overall 3D design for a building can include multiple stored design objects 144, including design objects 144 separately representing doors, windows, fixtures, walls, appliances, and so forth. The local data store 140 can also include data files 142 relating to a generated overall 3D design (e.g., component files, metadata, etc.). Additionally or alternatively, the local data store 140 includes data files 142 related to generating prompts for transmission to the one or more ML models 180, 190. For example, the local data store 140 can store one or more data files 142 for sketches, geometries (e.g., wireframes, meshes, etc.), images, videos, application states (e.g., camera angles used within a design space, tools selected by a user, etc.), audio recordings, and so forth. In some embodiments, the local data store 140 stores one or more digital content items created via the design exploration application 130. For example, the local data store 140 can store 2D images created directly by the user or generated by the one or more ML models 180, 190.

The design objects 144 include geometries, textures, images, and/or other components that the design exploration application 130 uses to generate an overall 3D design. In various embodiments, the geometry of a given design object refers to any multi-dimensional model of a physical structure, including CAD models, meshes, and point clouds, as well as circuit layouts, piping diagrams, free-body diagrams, and so forth. In some embodiments, the design exploration application 130 stores multiple design objects 144 for a given 3D design and stores multiple iterations of a given target object that the ML models 180, 190. For example, the user can form an initial prompt using the design exploration application 130 and receive a first generated design object 144(1) from the trained ML model 180(1), then refine the prompt and receive a second generated design object 144(2) from the trained ML model 180(1).

The network 150 can be any technically feasible set of interconnected communication links, including a local area network (LAN), wide area network (WAN), the World Wide Web, or the Internet, among others. The network 150 enables communications between the client device 110 and other devices in network 150 via wired and/or wireless communications protocols, including Bluetooth, Bluetooth low energy (BLE), wireless local area network (WiFi), cellular protocols, satellite networks, and/or near-field communications (NFC).

The server device 160 is configured to communicate with the design exploration application 130 to generate one or more design objects 144. In operation, the server device 160 executes the intent management application 170 to process a prompt generated by the design exploration application 130, select one or more ML models 180, 190 trained to generate design objects 144 in response to the contents of the prompt, and input the prompt into the selected ML models 180, 190. Once the selected ML models 180, 190 generate the design objects 144 that are responsive to the prompt, the server device 160 transmits the generated design objects to the client device 110, where the generated design objects 144 are usable by the design exploration application 130.

In various embodiments, the processor 162 can be any instruction execution system, apparatus, or device capable of executing instructions. For example, the processor 162 could comprise a central processing unit (CPU), a digital signal processing unit (DSP), a microprocessor, an application-specific integrated circuit (ASIC), a neural processing unit (NPU), a graphics processing unit (GPU), a field-programmable gate array (FPGA), a controller, a microcontroller, a state machine, or any combination thereof. In some embodiments, the processor 162 is a programmable processor that executes program instructions to manipulate input data. In some embodiments, the processor 162 can include any number of processing cores, memories, and other modules for facilitating program execution.

The input/output (I/O) devices 164 include devices configured to receive input, including, for example, a keyboard, a mouse, and so forth. In some embodiments, the I/O devices 164 also includes devices configured to provide output, including, for example, a display device, a speaker, and so forth. Additionally or alternatively, the I/O devices 164 may further include devices configured to both receive and provide input and output, respectively, including, for example, a touchscreen, a universal serial bus (USB) port, and so forth.

The memory 166 includes a memory module, or collection of memory modules. In some embodiments, the memory 166 can include a variety of computer-readable media selected for their size, relative performance, or other capabilities: volatile and/or non-volatile media, removable and/or non-removable media, etc. The memory 166 can include cache, random access memory (RAM), storage, etc. The memory 166 can include one or more discrete memory modules, such as dynamic RAM (DRAM) dual inline memory modules (DIMMs). Of course, various memory chips, bandwidths, and form factors may alternately be selected. The memory 166 stores content, such as software applications and data, for use by the processor 162. In some embodiments, a storage (not shown) supplements or replaces the memory 166. The storage can include any number and type of external memories that are accessible to the processor 162 of the server device 160. For example, and without limitation, the storage can include a Secure Digital (SD) Card, an external Flash memory, a portable compact disc read-only memory, an optical storage device, a magnetic storage device, or any suitable combination of the foregoing.

Non-volatile memory included in the memory 166 generally stores one or more application programs including the intent management application 170 and one or more trained ML models 180, and data (e.g., design history 182) for processing by the processor 112. In various embodiments, the memory 166 can include non-volatile memory, such as optical drives, magnetic drives, flash drives, or other storage. In some embodiments, separate data stores, such as one or more external data stores connected via the network 150 can supplement the memory 166. In various embodiments, the intent management application 170 and/or the one or more ML models 180 within the memory 166 can be executed by the processor 162 to implement the overall functionality of the server device 160 to coordinate the operation of the system 100 as a whole.

In various embodiments, the memory 166 can include one or more modules for performing various functions or techniques described herein. In some embodiments, one or more of the modules and/or applications included in the memory 166 may be implemented locally on the client device 110, server device 160, and/or may be implemented via a cloud-based architecture. For example, any of the modules and/or applications included in the memory 166 could be executed on a remote device (e.g., smartphone, a server system, a cloud computing platform, etc.) that communicates with the server device 160 via a network interface or an I/O devices interface. Additionally or alternatively, the intent management application 170 could be executed on the client device 110 and can communicate with the trained ML models 180 operating at the server device 160.

In various embodiments, the intent management application 170 receives a prompt from the design exploration application 130 and inputs the prompt into an applicable ML model 180, 190. In some embodiments, the intent management application 170 maintains a multiparty interface (not shown) that serves as a communication channel between one or more client devices 110 and the ML models 180, 190. In such instances, the intent management application 170 and or the ML models 180, 190 participating in the multiparty interface can process inputs provided by the client devices 110 to determine whether the inputs include prompts for the ML models 180, 190 to generate outputs. In some embodiments, one or more of the ML models 180, 190 are trained to respond to specific types of inputs, such as a ML model that is trained to generate design objects 144 from a specific combination of modalities (e.g., text and images). In such instances, the intent management application 170 processes a prompt to determine the modalities of the data that are included in the prompt and identifies one or more ML models 180, 190 that have been trained to respond to such a combination of modalities. Upon identifying the one or more ML models that are applicable, the intent management application 170 selects an ML model (e.g., the trained ML model 180(1)) and inputs the prompt into the selected ML model 180(1).

The trained ML models 180 include one or more generative ML models that have been trained on a relatively large amount of existing data and optionally any number of results (e.g., design objects 144 and evaluations provided by the user) to perform any number and/or types of prediction tasks based on patterns detected in the existing data. In various embodiments, the remote ML models 190 are trained ML models that communicate with the server device 160 to receive prompts via the intent management application 170. In some embodiments, the trained ML model 180 is trained using various combinations of data from multiple modalities, such as textual data, image data, sound data, and so forth. The trained ML model 180 and/or the remote ML model 190 trained using at least two modalities of data are also referred to herein as a multimodal ML model. For example, in some embodiments, the one or more trained ML models 180 can include a third-generation Generative Pre-Trained Transformer (GPT-3) model, a specialized version of a GPT-3 model referred to as a “DALL-E2” model, a fourth-generation Generative Pre-Trained Transformer (GPT-4) model, and so forth. In various embodiments, the trained ML models 180 can be trained to generate design objects from various combinations of modalities. Such combinations include text, a CAD object, a geometry, an image, a sketch, a video, an application state, an audio recording, etc.).

The design history 182 includes data and metadata associated with the one or more trained ML models 180 and/or the one or more remote ML models 190 generating design objects 144 in response to prompts provided by the design exploration application 130. In some embodiments, the design history 182 includes successive iterations of design objects 144 that a single ML model 180 generates in response to a series of prompts. Additionally or alternatively, the design history 182 includes multiple design objects 144 that were generated by different ML models 180, 190 in response to the same prompt. In some embodiments, the design history 182 includes feedback provided by one or more users and/or one or more ML models 180, 190 (e.g., a ML model trained to output an evaluation of a design object) for a given design object 144. In such instances, the server device 160 can use the design history 182 as training data to further train the one or more ML models 180. Additionally or alternatively, the design exploration application 130 can retrieve contents of the design history 182 and display the retrieved contents to the user via the GUI 120.

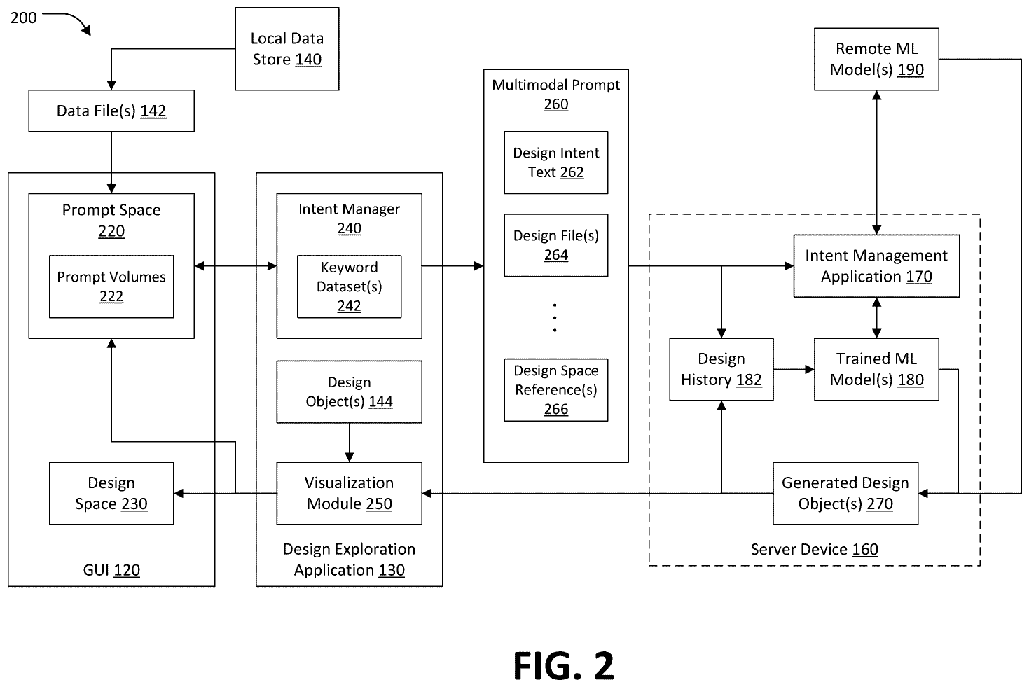

FIG. 2 is a more detailed illustration of the design exploration application 130 of FIG. 1, according to various embodiments. As shown, in some embodiments, the system 200 includes, without limitation, the GUI 120, the design exploration application 130, local data store 140, the one or more data files 142, the server device 160, the remote ML models 190, and a multimodal prompt 260. The GUI 120 includes, without limitation, a prompt space 220 including one or more prompt volumes 222, and a design space 230. The design exploration application 130 includes, without limitation, an intent manager 240 including one or more keyword datasets 242, the one or more design objects 144, and a visualization module 250. The server device 160 includes, without limitation, the intent management application 170, the one or more trained models 180, the design history 182, and one or more generated design objects 270. The multimodal prompt 260 includes, without limitation, design intent text 262, one or more design files 264, and one or more design space references 266.

For explanatory purposes only, the functionality of the design exploration application 130 is described herein in the context of exemplar interactive and linear workflows used to generate the generated design object 270 in accordance with user-based design-related intentions expressed during the workflow. The generated design object 270 includes, without limitation, one or more images, wireframe models, geometries, and/or meshes for use in a three-dimensional design, as well as any amount (including none) and/or types of associated metadata.

As persons skilled in the art will recognize, the techniques described herein are illustrative rather than restrictive and can be altered and applied in other contexts without departing from the broader spirit and scope of the inventive concepts described herein. For example, the techniques described herein can be modified and applied to generate any number of generated design objects 270 associated with any target content item in a linear fashion, a nonlinear fashion, an iterative fashion, a non-iterative fashion, a recursive fashion, a non-recursive fashion, or any combination thereof during an overall process for generating and evaluating designs for that target 3D object. A target 3D object can include any number (including one) and/or types of target content item and/or target content item components.

For example, in some embodiments, a generated design object 270 can be generated and displayed within the GUI 120 during a first iteration, any portion (including all) of the design object 270 can be selected via the GUI 120, and a first prompt multimodal prompt 260 can be set equal to the selected portion of the generated design object 270 to recursively generate a second generated design object 270 during a second iteration. In the same or other embodiments, the design exploration application 130 can display and/or re-display any number of GUI elements, generate and/or regenerate any amount of data, or any combination thereof any number of times and/in any order while generating each new generated design object 270.

In operation, the visualization module 250 of the design exploration application 130 provides the prompt space 220 and the design space 230 via the GUI 120. A user provides the contents for the multimodal prompt 260 via the prompt space 220. The design exploration application 130 processes the content to generate the multimodal prompt 260 and transmits the multimodal prompt 260 to the server device 160. The intent management application 170 identifies the modalities of the data included in the multimodal prompt 260 and identifies one or more trained ML models 180 and/or remote ML models 190 that have been trained to process the identified combination of modalities. The intent management application 170 inputs the multimodal prompt into one or more of the identified ML models 180, 190. The ML models 180, 190 respond to the multimodal prompt 260 by generating one or more design objects 270. The visualization module 250 receives the one or more generated design objects 270 and displays the one or more generated design objects 270 in the prompt space 220 and/or the design space 230.

In various embodiments, the design space 230 is a virtual workspace that includes one or more renderings of design objects (e.g., geometries of the design objects 144 and/or the generated design objects 270) that form an overall design for a content item (e.g., an overall 3D design). In some embodiments, the design space 230 includes multiple design alternatives for the overall design. For example, the design space 230 may graphically organize multiple designs that include differing combinations of design objects 144, 270. In such instances, the user interacts with the GUI 120 to navigate between design alternatives to quickly analyze tradeoffs between different design options, observe trends in design options, constrain the design space 230, select specific design options, and so forth.

The prompt space 220 is panel or volume in which a user can generate prompts, such as the multimodal prompt 260 and/or the one or more prompt volumes 222. In some embodiments, the prompt space 220 is a panel, such as a window separate from the design space. For example, the prompt space 220 can include a multiparty interface (not shown) that communicates with the trained ML model 180 and/or one or more other client devices 110. Alternatively, in some embodiments, the prompt space 220 is a volume that is overlayed over at least a portion of the design space. In such instances, a user can invoke a prompt volume 222 and/or an input area for a multimodal prompt 260 at various locations within the design space 230.

The prompt volume 222 is a form of a prompt that executes operations within the boundaries of the volume. The prompt volume 222 is a volume within the design space that is defined by a corresponding prompt definition that specifies how objects appear and/or behave within the boundaries of the prompt volume 222. The prompt volume 222 exerts a “sphere of influence” (e.g., a volume of influence based on the boundaries) within the defined boundaries such that modifications made to the associated prompt definition causes changes to design objects within the boundaries. For example, the prompt definition enables the user to specify design intent text and/or non-textual inputs for objects that at least partially overlap the prompt volume 222. The prompt volume 222 a set of characteristics, including a spatial position (e.g., location and orientation), boundaries (defined via the textual definition or via user input within the prompt space 220), and shape (e.g., a sphere, a cuboid, a pyramid, an irregular 3D shape, etc.). In some embodiments, the prompt volume 222 includes weighted areas, weighted gradients, and/or linked prompt volumes (e.g., prompt volumes 222(1)-222(x)). In such instances, the linked prompted volumes include other overlapping prompt volumes and/or other prompt volumes linked in a hierarchy.

In various embodiments, when the user modifies the prompt volume 222, the prompt volume executes by updating one or more design objects 144, 270 that are within the sphere of influence of the prompt volume 222. For example, upon detecting a change to the prompt definition, the prompt volume 222 can receive a newly generated design object 270 and replace an existing design object 144 that is within the prompt volume 222. Additionally or alternatively, in some embodiments, the prompt volume 222 applies weighted values corresponding to the weighted areas and/or weighted gradients of the prompt volume. Upon executing the updates, the prompt volume 222 can cause the design exploration application 130 to generate a message indicating the change and “transmit” the message to other linked prompt volumes 222. In such instances, the prompt volumes 222 propagate changes among linked prompt volumes 222, which enables users to make modifications to multiple volumes within the design space 230 without applying global changes to the entire design space 230.

In various embodiments, the intent manager 240 determines the intent of inputs provided by the user. For example, the intent manager 240 can comprise a natural language (NL) processor that parses text provided by the user. Additionally or alternatively, the intent manager 240 can include an audio processor that processes audio data to identify words included in audio data and parse the identified words. In some embodiments, the intent manager 240 is included in the intent management application 170 and/or the trained ML model 180. In such instances, the intent management application 170 and/or the trained ML model 180 can determine the intent of inputs provided by the user via the multiparty interface.

In various embodiments, the intent manager 240 identifies one or more keywords in textual data. In some embodiments, the intent manager 240 includes one or more keyword datasets 242 that the intent manager 240 references when identifying the one or more keywords included in textual data. For example, the keyword datasets 242 can include, without limitation, a 3D keyword dataset that includes any number and/or types of 3D keywords, a customized keyword dataset that includes any number and/or types of customized keywords, and/or a user keyword dataset that includes any number and/or types of user keywords (e.g., words and/or phrases specified by a user). The keywords can comprise particular words or phrases (e.g., demonstrative pronouns, technical terms, referential terms, etc.) that are relevant to designing 3D objects. For example, a user can input a regular sentence (“I want a hinge to connect here”) within an input area within the prompt space 220. The intent manager identifies “hinge,” “connect,” and “here” as words relevant to the ML model 180, 190 generating a design object 270. In such instances, the intent manager 240 can update the prompt space 220 by highlighting the keywords, enabling the user to provide additional details (e.g., non-textual data) for inclusion in the multimodal prompt 260.

In various embodiments, the visualization module 250 displays the design space 230 and/or the prompt space 220 via the GUI 120. In some embodiments, the visualization module 250 updates the prompt space 220 and/or the design space 230 based on inputs by the user and/or data received from the server device 160. For example, the visualization module 250 can initially respond to the user invoking a prompt via a hotkey or a marking menu within the prompt space 220 by displaying an input area to receive data to include in the multimodal prompt 260. When the user initially inputs a textual phrase, the visualization module 250 can respond to the intent manager 240 identifying one or more keywords by updating the input area to highlight the keywords and/or display contextual input areas proximate to at least one keyword. In this manner, the design exploration application 130 iteratively receives multiple modalities of input data to include into the multimodal prompt 260.

In various embodiments, the design exploration application 130 receives textual and/or non-textual data to include in the multimodal prompt 260 via the input areas included in the prompt space 220. When providing non-textual data, the user can retrieve stored data, such as one or more stored data files 142 (e.g., stored geometries, stored CAD files, audio recordings, stored sketches, etc.) from the local data store 140. Additionally or alternatively, the user can retrieve contents from the design history 182 and can add the contents into the input area. In such instances, the contents from the design history 182 is stored in one or more data files 142 that the user retrieves from the local data store 140.

The multimodal prompt 260 is a prompt that includes two or more modalities of data (e.g., textual data, image data, audio data, etc.) that specifies the design intent of the user. In various embodiments, the design exploration application 130 receives multiple types of data and builds the multimodal prompt 260 to include each of the multiple types of data. For example, a user can initially write design intent text 262 that refers to a sketch. The design exploration application 130 then receives a sketch (e.g., a stored sketch or a sketch the user inputs into an input design area). Upon receiving the sketch, the design exploration application 130 can then generate the multimodal prompt 260 to include both the design intent text 262 and the sketch. In some embodiments, the multimodal prompt 260 can include multiple data inputs of the same modality. For example, the multimodal prompt 260 can include multiple design intent texts 262 (e.g., 262(1), 262(2), etc.) and/or multiple design files 264 (e.g., 264(1), 264(2), etc.).

Additionally or alternatively, in some embodiments, the intent management application 170 can generate the multimodal prompt 260. For example, a first user can initially write design intent text 262 to the multiparty interface. A second user can then provide a sketch to the multiparty interface. Upon receiving the sketch, the intent management application 170 can then generate the multimodal prompt 260 to include both the design intent text 262 and the sketch. As will be discussed in further detail below, the intent management application 170 can also weigh each component of the multimodal prompt 260. For example, the intent management application 170 can weigh each component of the multimodal prompt 260 by user (e.g., 0.8 to each input provided by the first user, 0.2 to each input provided by the second user). Alternatively, the intent management application 170 can weigh each component of the multimodal prompt 260 individually (e.g., 0.4 to the design intent text 262, 0.6 to the sketch).

The design intent text 262 includes textual data that describes the intent of the user. For example, the design intent text can include descriptions for characteristics of a target 3D design object (e.g., a handle made of titanium″). In some embodiments, the design exploration application 130 generates the design intent text 262 from a different type of data input. For example, the intent manager 240 can perform NL processing to identify words included in an audio recording. In such instances, the design exploration application 130 generates the design intent text 262 that includes the identified words.

The design files 264 includes one or more files (e.g., CAD files, stored text, audio recordings, stored geometries, etc.) that the user adds to be included in the multimodal prompt 260. In some embodiments, the design files 264 can include textual data (e.g., textual descriptions, physical dimensions, etc.). In various embodiments, a user can add multiple design files 264 to include in the multimodal prompt 260. In some embodiments, the design exploration application 130 converts various types of data into the design files 264. For example, the user can record audio via the input area. In such instances, the design exploration application 130 can store audio recording as a design file 264. The design files 264 can include one or more modalities (e.g., textual data, video data, audio data, image data, etc.).

In some embodiments, the design space references 266 can include one or more references to the prompt space 220 and/or the design space 230. For example, the user can input text that references a specific application state (e.g., “make the thing selected by the current tool lighter,” “generate a seat for the car in this view,” etc.). In such instances, the design exploration application 130 determines the application state the user is referencing. The design exploration application 130 can then include the reference in the multimodal prompt 260 as the design space reference 266.

In various embodiments, the intent management application 170 receives and processes the multimodal prompt 260 to identify the modalities of the contents of the multimodal prompt 260. For example, the intent management application 170 the modalities of the design intent text 262, the one or more design files 264, and/or the one or more design space references 266 included in the multimodal prompt 260. For example, the intent management application 170 can identify a combination of text, image, and video modalities included in the multimodal prompt. The intent management application 170 identifies at least one ML model 180, 190 that was trained with that combination of modalities and selects one of the identified ML models 180, 190. The intent management application 170 executes the selected ML model by inputting the multimodal prompt 260 into the selected ML model. The selected ML model generates a design object 270 in response to the multimodal prompt 260. In some embodiments, the server device includes the generated design object 270 in the design history 182. In such instances, the generated design object 270 is a portion of the design history 182 used as training data to train one or more trained ML models 180 (e.g., further training the selected ML model, training other ML models, etc.).

### Multi-User Prompts for Generative Artificial Intelligence Systems

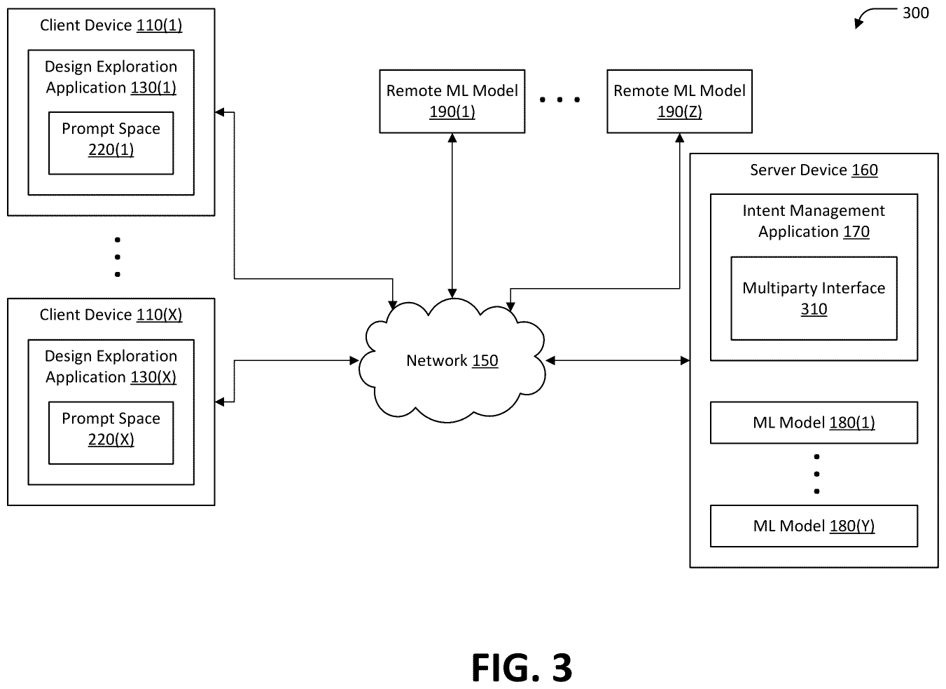

FIG. 3 is an exemplar illustration of a multi-user system 300 including the intent management application 170 of FIG. 2, according to various embodiments. As shown, in some embodiments, the multi-user system 300 includes, without limitation, a plurality of client devices 110 (e.g., 110(1), . . . 110(X)), the server device 160, and one or more remote ML models 190 (e.g., 190(1), . . . 190(Z)). The plurality of client devices 110 include, without limitation an instance of the design exploration application 130 (e.g., 130(1), . . . 130(X)) that each include a prompt space 220 (e.g., 220(1), . . . 220(X)). The server device 160 includes, without limitation, the intent management application 170, and a plurality of trained ML models 180 (e.g., 180(1), . . . 180(Y)). The intent management application 170 includes, without limitation, a multiparty interface 310. In some other embodiments, the system 100 can include any number and/or types of other client devices, server devices, remote ML models, or any combination thereof.

In various embodiments, the intent management application 170 manages a multiparty interface 310. The multiparty interface 310 is a communication channel that includes one or more of the client devices 110, one or more of the trained ML models 180, and/or one or more of the remote ML models 190 as participants. The client devices 110(1)-110(X) transmit inputs to the multiparty interface 310 via the respective prompt spaces 220. The intent management application 170 processes inputs received from the client devices 110(1)-110(X) to identify prompts for at least one ML model 180, 190. The intent management application 170 transmits the identified prompts to the applicable ML models 180, 190, where the applicable ML models 180, 190 respond to the identified prompts by generating digital content items as outputs.

In various embodiments, the multiparty interface 310 is a GUI that displays inputs provided by participants in a shared communications channel. For example, the multiparty interface 310 can display text, images, video, audio, and other inputs that are provided by the client devices 110(1)-110(X) and/or the ML models 180(1)-180(Y), 190(1)-190(Z). The inputs can be directed to other users (e.g., “Henry, what time is the meeting?”) or directed to at least one of the ML models 180, 190 generating digital content (e.g., “I need to design a logo for this sail.”). In such instances, the intent management application 170 can process each input and transmit one or more inputs to at least one of the ML models 180, 190 to generate an output.

In various embodiments, the intent management application 170 determines the likelihood that the input is directed to at least one ML model 180, 190. For example, the intent management application 170 can include an intent manager 240 (not shown) that determines the likelihood that a particular input transmitted by the client device 110(X) to the multiparty interface 310 is directed to the ML model 180(1). In such instances, the intent manager 240 can generate a confidence score for the first input and compare the confidence score to a predetermined threshold. When the intent manager 240 determines that the confidence score exceeds the predetermined threshold, the intent management application 170 determines that the input includes a prompt for the ML model 180(1) and transmits the prompt to the ML model 180(1).

Additionally or alternatively, in various embodiments, the intent management application 170 determines the likelihood that an output generated by a given ML model 180, 190 is responsive to the one or more inputs provided by the client devices 110(1)-110(X). In such instances, the intent management application 170 can generate a confidence score for the output, where the confidence score for the output indicates whether the output is responsive to the inputs. In some embodiments, the intent management application 170 collects a plurality of inputs and transmits the plurality of inputs to multiple ML models 180, 190. In such instances, the intent management application 170 can compute confidence scores for the outputs provided by each of the ML models 180, 190.

In various embodiments, the intent management application 170 combines and/or aggregates inputs from two or more client devices 110(1)-110(X) to generate a composite prompt for an ML model 180, 190. For example, the intent management application 170 can combine a textual input transmitted from the client device 110(1) and a textual input transmitted from the client device 110 (X0 to generate a composite prompt. In some embodiments, the composite prompt can comprise a multimodal prompt that includes inputs from two or more modalities. The inputs can be received from the same client device 110 (e.g., 110(1)) or from multiple client devices 110. For example, a first user can provide an input that includes a textual description, and a second user can provide an image. In such instances, the intent management application 170 can generate a multimodal prompt that includes the two inputs.

In some embodiments, the ML model 180, 190 can generate an output that is transmitted to a different ML model 180, 190. For example, multiple users can provide inputs for a first ML model 180, 190 (e.g., remote ML model 190(Z)) to generate a prompt for a second ML model (e.g., the trained ML model 180(Y)) to receive as an input. In another example, the multiple users can provide inputs for the second ML model 180(Y) to generate a digital content item (e.g., a generated design object 270) as an output, then for a third ML model (e.g., 190(1)) to evaluate the generated design object 270 generated by the second ML model 180(Y).

In various embodiments, the intent management application 170 displays the inputs provided by the client devices 110(1)-110(X), the ML models 180(1)-180(Y), and/or the remote ML models 190(1)-190(Z) in the multiparty interface. Additionally or alternatively, the inputs provided to the multiparty interface 310 are selectable and transferrable to the design exploration application 130. For example, the first user can select the generated design object 270 and move the generated design object into the design space 230.

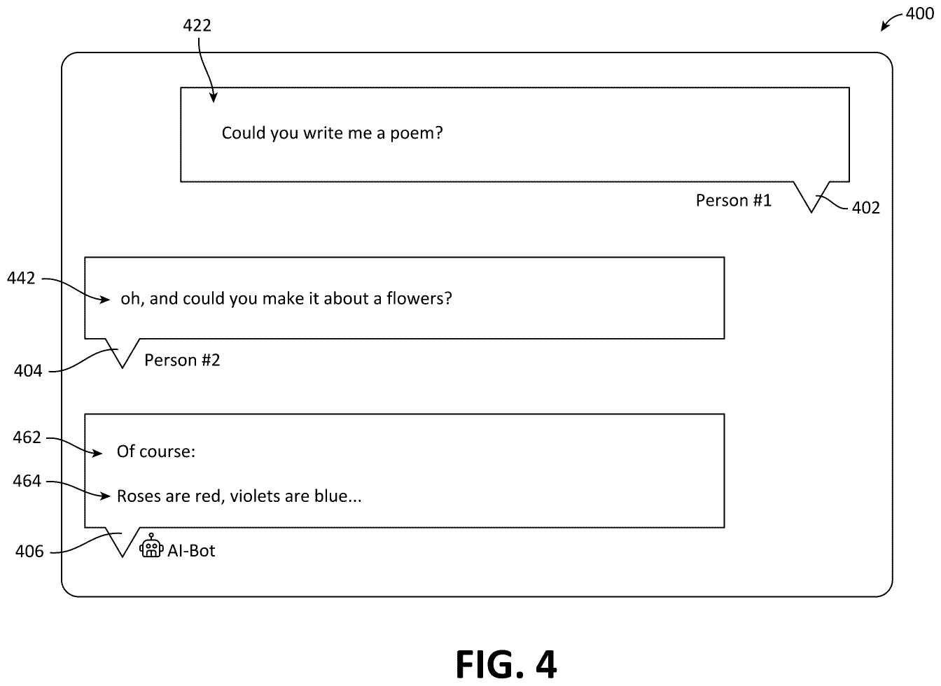

FIG. 4 is an exemplar illustration of the multiparty interface 310 of FIG. 3, according to various embodiments. As shown, the multiparty interface 400 includes, without limitation, a first user input 402 comprising a first textual prompts 422, a second user input 404 comprising a second textual prompt 442, and an AI response 406 comprising a textual response 462 and a generated digital content item 464.

In various embodiments, the intent management application 170 generates the multiparty interface 310 that communicates with a plurality of client devices 110 and one or more ML models 180, 190. As shown, the multiparty interface 400 is a GUI that displays inputs provided by user participants (e.g., inputs 402, 404) and a non-user participant (e.g., the AI response 406). In some embodiments, the intent management application 170 processes each of the inputs 402, 404 provided by the user participants to determine whether a portion of the inputs 402, 404 are directed to the non-user participant. For example, the intent management application 170 can include an intent manager 240 that determines the likelihood that a user input 402, 404 is directed to the non-user participant. In such instances, the intent manager 240 can generate confidence scores for the respective inputs 402, 404 and compare the respective confidence scores to a predetermined threshold. When the intent manager 240 determines that a confidence score exceeds the predetermined threshold, the intent manager 240 determines that the input 402, 404 includes a prompt for the non-user participant (e.g., the ML model 180(1)) and transmits the prompt to the ML model 180(1). Alternatively some embodiments, the non-user participant determines whether to respond to the inputs 402, 404.

In some embodiments, the intent management application 170 can extract the prompt 422 included in the input 402 and/or the prompt 442 included into the input 404. In such instances, the intent management application 170 can combine and/or aggregate the prompts 422, 442 to generate a composite prompt. The intent management application 170 can then transmit the composite prompt to the trained ML model 180(1) to generate a response. For example, the intent management application 170 can extract the prompt 422 (requesting a type of textual output) from the inputs 402 and extract the prompt 442 (requesting a theme for the textual output) from the input 404. In such instances, the intent management application 170 can generate a single, composite prompt that contains both prompts 422, 442, which specify different requirements for the ML model 180(1) to output. Alternatively, in some embodiments, the intent management application 170 can transmit each prompt 422, 442 separately. In such instances, the ML model 180(1) can be trained to receive multiple inputs and generate an output that is responsive to each input.

The trained ML model 180(1) responds to receiving the composite prompt by generating the digital content item 464 as an output. The digital content item 464 is generated with characteristics that are responsive to the ideas and constraints specified by the combination of the prompts 422, 442. Upon generating an output, the trained ML model 180(1), acting as the non-user participant, provides the AI response 406 to the multiparty interface 400. The AI response 406 includes the textual input 462. The textual input 462 indicates that the non-user participant is responding to the prompts 422, 442. The AI response 406 also includes the digital content item 464. Once the digital content item 464 is posted to the multiparty interface 400, each participant can select the digital content item 464 for local use. For example, the first user can select the digital content item 464 and store the digital content item 464 as a local copy in the local data store 140(1). The local copy can then be added to the design space 230 included in the design exploration application 130(1) locally executing on the client device 110(1).

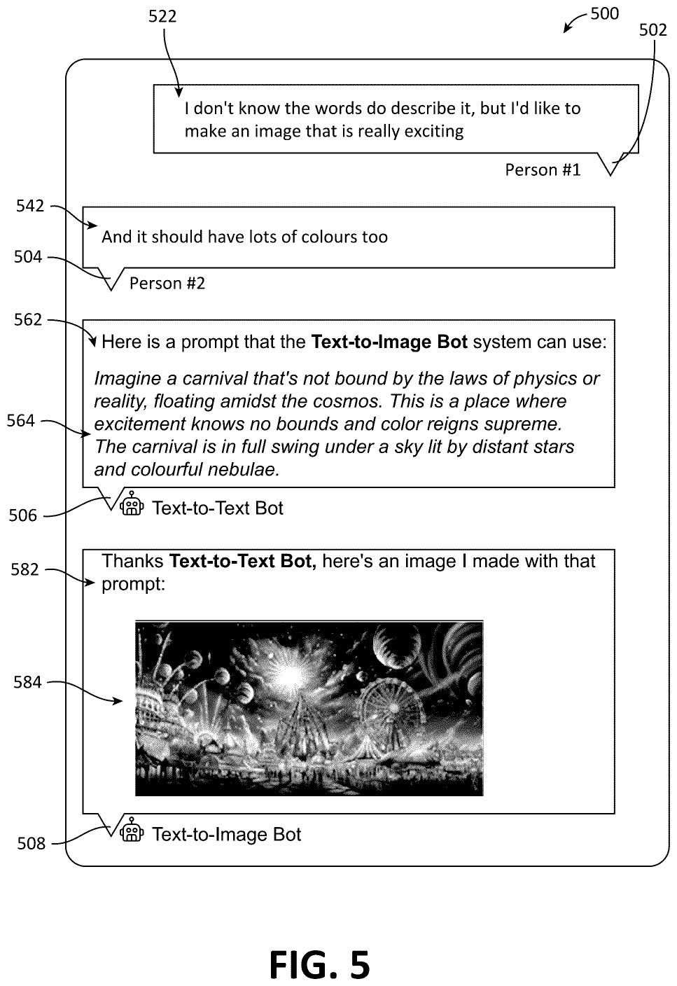

FIG. 5 is an exemplar illustration of another multiparty interface 310 of FIG. 3, according to various other embodiments. As shown, the multiparty interface 500 includes, without limitation, a first user input 502 comprising a first textual prompts 522, a second user input 504 comprising a second textual prompt 542, a first AI response 506 comprising a textual response 562 and a generative prompt 564, and a second AI response 508 comprising a textual response 582 and a digital content item 584.

The multiparty interface 500 is similar to the multiparty interface 500. As shown, the multiparty interface includes two inputs 502, 504 from user participants and two inputs 506, 508 from non-user participants (e.g., a remote ML model 190(1) and a trained ML model 180(Y)). In various embodiments, the intent management application 170 and/or each of the non-user participants can determine whether any of the inputs 502, 504 provided by the user participants contain prompts for a ML model 180, 190 to generate an output. For example, the intent management application 170 can execute the intent manager 240 to parse the text of the input 502 to determine that the user is referring to a goal (e.g., an image) for an output. The intent manager 240 can also identify other keywords (“I don't know the words to describe it”) that modify the goal and identify a different type of output (e.g., a prompt for generating an image) that an ML model 180, 190 is to produce. In such instances, the intent management application 170 can transmit the prompt 522 included in the input 502 to the remote ML model 190(1) to generate a textual prompt in lieu of transmitting the prompt 522 to the trained ML model 180(Y) to generate an image.

Alternatively, in some embodiments, the remote ML model 190(1) and/or the trained ML model 180(Y) can process the input 502 to determine whether to respond to the input 502 by generating an output. In such instances, each of the remote ML model 190(1) and/or the trained ML model 180(Y) can generate a confidence score for the input 502. Each of the remote ML model 190(1) and/or the trained ML model 180(Y) can then compare the confidence score to a predetermined threshold. The confidence score exceeds the predetermined threshold, the remote ML model 190(1) and/or the trained ML model 180(Y). For example, the remote ML model 190(1) can compute a first confidence score for the input 502 that exceeds a first predetermined threshold. In such instances, the remote ML model 190(1) can detect the prompt 522 included in the input 502 and respond to the prompt 522 by generating a textual output (e.g., the generative prompt 564). The trained ML model 180(Y) can compute a second confidence score for the input 502 that does not exceed a second predetermined threshold. In such instances, the trained ML model 180(Y) does not respond to the input 502.

In various embodiments, the ML model 190(1) responds to a plurality of inputs. For example, the intent management application 170 can determine that each input 502, 504 includes a prompt for the remote ML model 190(1). The intent management application 170 can then generate a composite prompt containing the prompts 522, 542 extracted from the inputs 502, 504. The intent management application 170 can then transmit the composite prompt to the ML model 190(1), where the remote ML model 190(1) receives the composite prompt as an input. Alternatively, in some embodiments, the intent management application 170 transmits each prompt 522, 542 as a separate input. In such instances, the remote ML model 190(1) responds to the plurality of prompts 522, 542 by generating an output.

In various embodiments, the ML model 190(1) can generate an output that is transmitted to a different ML model 180, 190. For example, multiple users can provide inputs 502, 504 for the remote ML model 190(1) to generate a prompt for the trained ML model 180(Y) to receive as an input. The remote ML model 190(1) can then produce the generative prompt 564 as an output. In some embodiments, the remote ML model 190(1), transmits the generative prompt 564 to the multiparty interface. For example, the remote ML model 190(1) posts the AI response 506 that includes a textual input 562 responding to the inputs 502, 504, and the generative prompt 564. In such instances, the intent management application 170 can transmit the generative prompt to the trained ML model 180(Y) in order to have the trained ML model 180(Y) generate a digital content item (e.g., an image) that is responsive to the generative prompt 564. Alternatively, in some embodiments, the remote ML model 190(1) generates and transmits an output directly to the trained ML model 180(Y). In such instances, the remote ML model 190(1) can provide an AI response 506 indicating that the transmission of the output occurred without posting the output to the multiparty interface 500.

In various embodiments, the trained ML model 180(Y) generates a digital content item in response to the generative prompt 564 produced by the remote ML model 190(1). In such instances, the trained ML model 180(Y) responds to the generative prompt 564 by generating a digital content item 584 that adheres to the goals, constraints, and requirements included in the generative prompt 564. Upon generating the digital content item 584, the trained ML model 180(Y) can then transmit an input 508 that includes a textual response 582 to the generative prompt 564 and the digital content item 584. In such instances, the digital content item 584 can be copied from the multiparty interface 500 for local use by each participant of the multiparty interface 500.

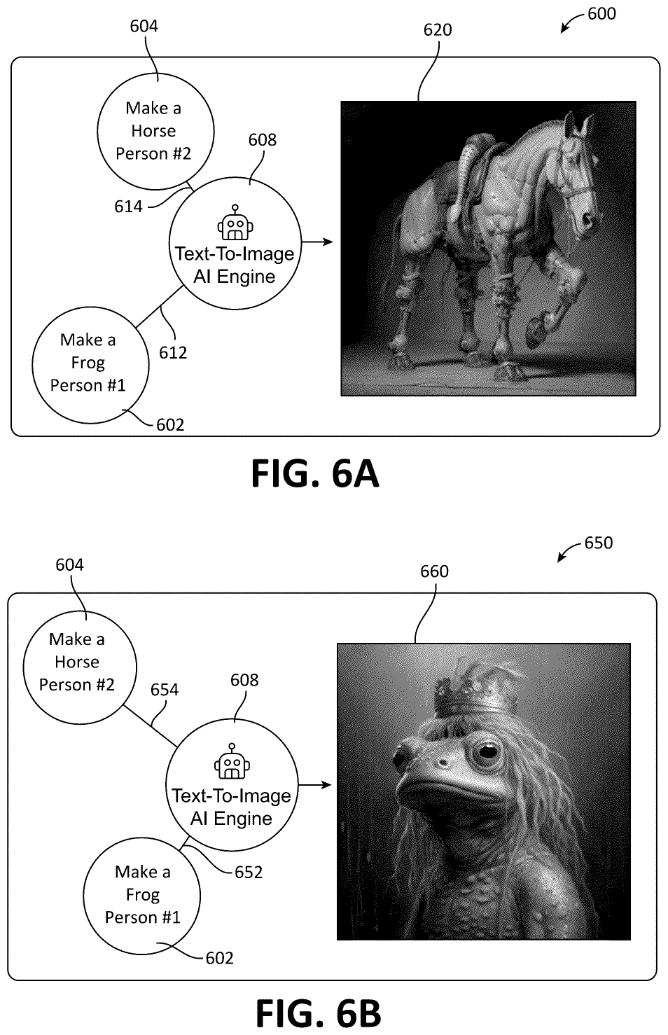

FIG. 6A is an exemplar illustration of a weighting interface 600 implemented by the intent management application 170 of FIG. 3, according to various embodiments. As shown, the weighting interface 600 includes, without limitation, a first user 602 including a first prompt 622, a second user 604 including a second prompt 624, a ML model 608, a first weighting length 612, a second weighting length 614, and a digital content item 630.

In operation, the intent management application 170 can generate the weighting interface 600 to enable one or more user participants of the multiparty interface 310 to weigh inputs (e.g., the prompts 622, 624). In some embodiments, the weighting can be designated based on the user. In such instances, the intent management application 170 can apply the user-specific weight value to each input the user provides. Alternatively, the weighting can be designated for each individual input. In such instances, the intent management application 170 can apply weight values for each individual input. The intent management application 170 can then transmit the weighted input or include the weighted input in a composite prompt for a ML model 180, 190.

In some embodiments, the weighting interface 600 indicates a relative weight based on inputs to the weighting interface 600. For example, the weighting interface 600 can include a graphical interface that indicates a relative weighting of inputs to the ML model 608 based on an inverse of distances to the user participants. As shown, the weighting length 614 is shorter than the weighting length 612, indicating a greater weight value (e.g., a second weight value 0.7) for the second prompt 624 relative to the weight value (e.g., a first weight value 0.4) for the first prompt 622. The ML model 608 responds to the combination of weighted prompts (e.g., a combination of the prompt 622 and the first weight value and a combination of the prompt 624 and the second weight value) by generating a digital content item 630 that is more responsive to the prompt 624 than the prompt 622 (e.g., generating a horse with some frog-like features).

FIG. 6B is an exemplar illustration of another weighting interface 650 implemented by the intent management application 170 of FIG. 3, according to various other embodiments. As shown, the weighting interface 650 includes, without limitation, the first user 602 including the first prompt 622, the second user 604 including the second prompt 624, the ML model 608, a third weighting length 652, a fourth weighting length 654, and a second digital content item 670.

As shown, the weighting interface 650 indicates a relative weight differing from the relative weight indicated in the weighting interface 600. The weighting interface 650 indicates a relative weighting of inputs to the ML model 608 based on an inverse of distances to the user participants. For example, the third weighting length 652 is shorter than the fourth weighting length 654, indicating a greater weight value (e.g., a third weight value 0.8) for the second prompt 624 relative to a weight value (e.g., a fourth weight value 0.4) for the first prompt 622. The ML model 608 responds to the combination of weighted prompts (e.g., a combination of the prompt 622 and the first weight value and a combination of the prompt 624 and the second weight value) by generating a digital content item 670 that is more responsive to the prompt 622 than the prompt 624 (e.g., generating a frog with some horse-like features).

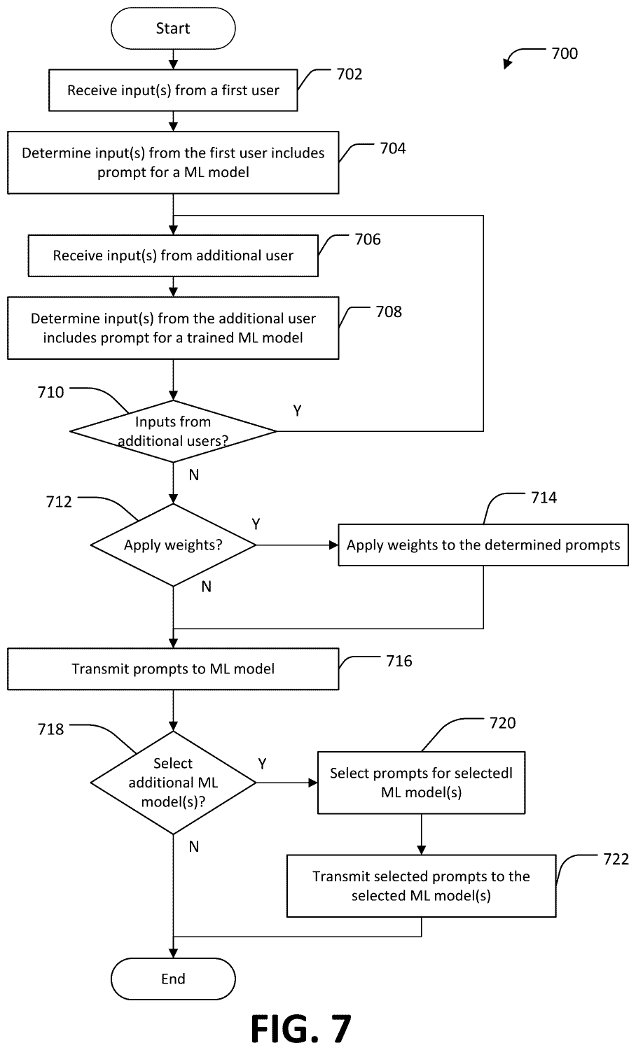

FIG. 7 sets forth a flow diagram of method steps for generating digital content items, according to various embodiments. Although the method steps are described with reference to the systems of FIGS. 1-6B, persons skilled in the art will understand that any system configured to implement the method steps, in any order, falls within the scope of the embodiments.

As shown, a method 700 begins at step 702, where the server device 160 receives one or more inputs from a first user. In various embodiments, the intent management application 170 generates a multiparty interface 310 for a communication channel that communicates with multiple user participants. In some embodiments, the multiparty interface 310 includes one or more ML models 180, 190 (e.g., the trained ML model 180(1)) as a non-user participant. In such instances, the intent management application 170 can receive various inputs from the participants. For example, the intent management application 170 can receive one or more first inputs from a first user via a first client device 110(1). In some embodiments, the intent management application 170 receives the first inputs consecutively. Alternatively, in some embodiments, the intent management application 170 receives the first inputs interspersed among inputs received from other participants. In various embodiments, the intent management application 170 displays the received first inputs in a graphical user interface representing the multiparty interface 310.

At step 704, the server device 160 determines that the one or more inputs from the first user includes a prompt for a ML model. In various embodiments, the intent management application 170 parses the received first inputs to determine whether the first inputs include at least one prompt for an ML model. For example, the intent management application 170 can include an intent manager 240 that parses a textual input to determine whether the textual input includes a prompt for the trained ML model 180(1). In some embodiments, the intent manager 240 can generate a confidence score that the first inputs include a prompt for the trained ML model 180(1). In such instances, the intent management application 170 determines that the first inputs include a prompt for the trained ML model 180(1) when the confidence score exceeds a predetermined threshold associated with the trained ML model 180(1).

At step 706, the server device 160 receives one or more inputs from an additional user. In various embodiments, the intent management application 170 receives one or more second inputs from a second user via a second client device 110(2). In some embodiments, the intent management application 170 receives the second inputs consecutively. Alternatively, in some embodiments, the intent management application 170 receives the second inputs interspersed among inputs received from other participants. In various embodiments, the intent management application 170 displays the received second inputs in a graphical user interface representing the multiparty interface 310.

At step 708, the server device 160 determines that the one or more inputs from the additional user includes a prompt for the ML model. In various embodiments, the intent management application 170 parses the received second inputs to determine whether the second inputs include at least one prompt for the ML model. For example, the intent manager 240 can parse a textual input to determine whether the textual input includes a prompt for the trained ML model 180(1). In some embodiments, the intent manager 240 can generate a confidence score that the second inputs include a prompt for the trained ML model 180(1). In such instances, the intent management application 170 determines that the second inputs include a prompt for the trained ML model 180(1) when the confidence score exceeds the predetermined threshold associated with the trained ML model 180(1).

At step 710, the server device 160 determines whether inputs from an additional user are received. In various embodiments, the intent management application 170 determines to receive an input from an additional user (e.g., a third user). When the intent management application 170 determines to receive an input from an additional user, the intent management application 170 returns to step 706 to receive the input from the additional user. Otherwise, the intent management application 170 determines not to receive an input from an additional user, the intent management application 170 proceeds to step 712.

At step 712, the server device 160 determines whether to apply weights to the prompts determined to have been included in the received inputs. In various embodiments, the intent management application 170 determines whether to apply weight values to the prompts identified in the first inputs and the second inputs. When the intent management application 170 determines to apply weight values, the intent management application 170 proceeds to step 714. Otherwise, the intent management application 170 determines not to apply weight values (e.g., generating a composite prompt where each of the prompts are weighted equally) and proceeds to step 716.

At step 714, the server device 160 applies weights to the determined prompts. In various embodiments, the intent management application 170 applies weight values to each of the prompts that the intent management application 170 determined were included in the first inputs or the second inputs. For example, the intent management application 170 can receive weight values that are designated to specific users (e.g., a first weight value designated for the first user, a second weight value designated for the second user, etc.). In such instances, the intent management application 170 applies the weight value designated for a user to each prompt that user generated. Alternatively, in some embodiments, the intent management application 170 can receive specific weight values for specific prompts. For example, the intent management application 170 can receive weight values via inputs to the weighting interface 600, 650. In such instances, the intent management application 170 applies the weight value designated for the prompts.

At step 716, the server device 160 transmits the prompts to the trained ML model 180. In various embodiments, the intent management application 170 transmits each of the determined prompts to the trained ML model 180(1). In some embodiments, the intent management application 170 generates a composite prompt that includes each of the determined prompts, then transmits the composite prompt to the trained ML model 180(1). Alternatively, the intent management application 170 can send each of the determined prompts individually to the trained ML model 180(1).

At step 718, the server device 160 determines whether to select one or more additional ML models. In various embodiments, the intent management application 170 determines whether to select one or more additional models to generate a digital content item as an output. For example, the intent management application 170 can select a plurality of ML models 180, 190 that each respond to the same composite prompt. In another example, the intent management application 170 can determine that the trained ML model 180(1) generated an output (e.g., a generative prompt, a first digital content item) that is to be used as an input for one or more additional ML models 180, 190. When the intent management application 170 determines to select at least one additional ML model 180, 190, the intent management application 170 proceeds to step 720. Otherwise, the intent management application 170 determines not to select an additional ML model 180, 190 and ends the method 700.

At step 720, the server device 160 selects prompts for the one or more selected ML models. In various embodiments, the intent management application 170 selects a prompt for the one or more selected ML models 180, 190. In some embodiments, the trained ML model 180(1) generated a generative prompt, or a user-participant provided an additional prompt in response to the digital content item that the trained ML model 180(1) generated (e.g., a prompt including the digital content item). In such instances, the intent management application 170 can determine one or more additional ML models 180, 190 that are applicable to the generative prompt or additional prompt (e.g., a ML model that generates a type of digital content item specified in the generative prompt or the additional prompt). The intent management application 170 can then select one or more additional ML models 180, 190 that are to receive the generative prompt or additional prompt.

At step 722, the server device transmits the selected prompts to the one or more selected ML models. In various embodiments, the intent management application 170 transmits the generative prompt or additional prompt to the selected ML models 180, 190. The selected ML models 180, 190 generate digital content items in response to the generative prompt or the additional prompt. Upon generating the digital content items, the selected additional ML models 180, 190 transmit the digital content items to the multiparty interface 310. In such instances, the digital content items can be copied from the multiparty interface 310 for local use by each participant of the multiparty interface 310.

### System Implementation

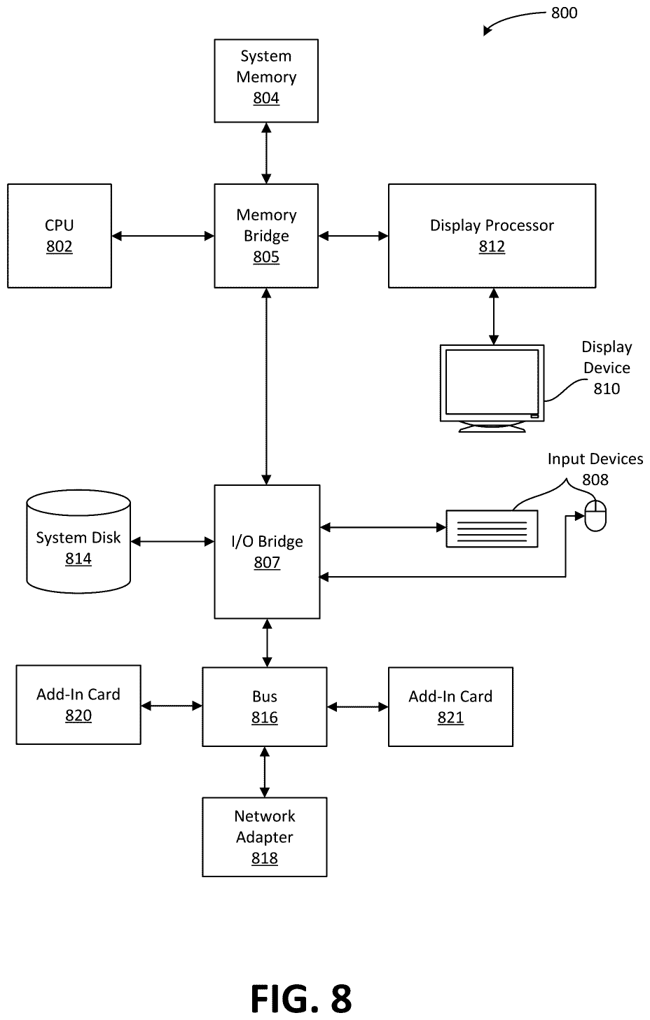

FIG. 8 depicts one architecture of a system 800 within which embodiments of the present disclosure may be implemented. This figure in no way limits or is intended to limit the scope of the present disclosure. In various implementations, system 800 may be an augmented reality, virtual reality, or mixed reality system or device, a personal computer, video game console, personal digital assistant, mobile phone, mobile device, or any other device suitable for practicing one or more embodiments of the present disclosure. Further, in various embodiments, any combination of two or more systems 800 may be coupled together to practice one or more aspects of the present disclosure.

As shown, system 800 includes a central processing unit (CPU) 802 and a system memory 804 communicating via a bus path that may include a memory bridge 805. CPU 802 includes one or more processing cores, and, in operation, CPU 802 is the master processor of system 800, controlling and coordinating operations of other system components. System memory 804 stores software applications and data for use by CPU 802. CPU 802 runs software applications and optionally an operating system. Memory bridge 805, which may be, e.g., a Northbridge chip, is connected via a bus or other communication path (e.g., a HyperTransport link) to an I/O (input/output) bridge 807. I/O bridge 807, which may be, e.g., a Southbridge chip, receives user input from one or more user input devices 808 (e.g., keyboard, mouse, joystick, digitizer tablets, touch pads, touch screens, still or video cameras, motion sensors, and/or microphones) and forwards the input to CPU 802 via memory bridge 805.

A display processor 812 is coupled to memory bridge 805 via a bus or other communication path (e.g., a PCI Express, Accelerated Graphics Port, or HyperTransport link); in one embodiment display processor 812 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 804.

Display processor 812 periodically delivers pixels to a display device 810 (e.g., a screen or conventional CRT, plasma, OLED, SED or LCD based monitor or television). Additionally, display processor 812 may output pixels to film recorders adapted to reproduce computer generated images on photographic film. Display processor 812 can provide display device 810 with an analog or digital signal. In various embodiments, one or more of the various graphical user interfaces set forth in Appendices A-J, attached hereto, are displayed to one or more users via display device 810, and the one or more users can input data into and receive visual output from those various graphical user interfaces.

A system disk 814 is also connected to I/O bridge 807 and may be configured to store content and applications and data for use by CPU 802 and display processor 812. System disk 814 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 816 provides connections between I/O bridge 807 and other components such as a network adapter 818 and various add-in cards 820 and 821. Network adapter 818 allows system 800 to communicate with other systems via an electronic communications network, and may include wired or wireless communication over local area networks and wide area networks such as the Internet.

Other components (not shown), including USB or other port connections, film recording devices, and the like, may also be connected to I/O bridge 807. For example, an audio processor may be used to generate analog or digital audio output from instructions and/or data provided by CPU 802, system memory 804, or system disk 814. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 812 incorporates circuitry optimized for graphics and video processing, including, for example, video output circuitry, and constitutes a graphics processing unit (GPU). In another embodiment, display processor 812 incorporates circuitry optimized for general purpose processing. In yet another embodiment, display processor 812 may be integrated with one or more other system elements, such as the memory bridge 805, CPU 802, and I/O bridge 807 to form a system on chip (SoC). In still further embodiments, display processor 812 is omitted and software executed by CPU 802 performs the functions of display processor 812.

Pixel data can be provided to display processor 812 directly from CPU 802. In some embodiments of the present disclosure, instructions and/or data representing a scene are provided to a render farm or a set of server computers, each similar to system 800, via network adapter 818 or system disk 814. The render farm generates one or more rendered images of the scene using the provided instructions and/or data. These rendered images may be stored on computer-readable media in a digital format and optionally returned to system 800 for display. Similarly, stereo image pairs processed by display processor 812 may be output to other systems for display, stored in system disk 814, or stored on computer-readable media in a digital format.

Alternatively, CPU 802 provides display processor 812 with data and/or instructions defining the desired output images, from which display processor 812 generates the pixel data of one or more output images, including characterizing and/or adjusting the offset between stereo image pairs. The data and/or instructions defining the desired output images can be stored in system memory 804 or graphics memory within display processor 812. In an embodiment, display processor 812 includes 3D rendering capabilities for generating pixel data for output images from instructions and data defining the geometry, lighting shading, texturing, motion, and/or camera parameters for a scene. Display processor 812 can further include one or more programmable execution units capable of executing shader programs, tone mapping programs, and the like.

Further, in other embodiments, CPU 802 or display processor 812 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 802, display processor 812, or one or more other processing devices or any combination of these different processors.

CPU 802, render farm, and/or display processor 812 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 800 may be a robot or robotic device and may include CPU 802 and/or other processing units or devices and system memory 804. In such embodiments, system 800 may or may not include other elements shown in FIG. 1. System memory 804 and/or other memory units or devices in system 800 may include instructions that, when executed, cause the robot or robotic device represented by system 800 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 804 is connected to CPU 802 directly rather than through a bridge, and other devices communicate with system memory 804 via memory bridge 805 and CPU 802. In other alternative topologies display processor 812 is connected to I/O bridge 807 or directly to CPU 802, rather than to memory bridge 805. In still other embodiments, I/O bridge 807 and memory bridge 805 might be integrated into a single chip. The particular components shown herein are optional; for instance, any number of add-in cards or peripheral devices might be supported. In some embodiments, switch 816 is eliminated, and network adapter 818 and add-in cards 1120, 1121 connect directly to I/O bridge 807.

In sum, the disclosed techniques can be used to generate digital content items, including 3D object designs based on design intentions expressed by inputs provided by two or more users via a GUI. In various embodiments, an intent management application generates a multiparty interface that communicates with at least one or more AI models and two or more users. The users communicate with the multiparty interface via instances of a design exploration application executing on different client devices. Each design exploration application displays a prompt space for a user to view a representation of the multiparty interface. In some embodiments, the prompt space overlaps the design space, where a user can invoke the multiparty interface anywhere in the design space. Alternatively, in some embodiments, the prompt space is separate from the design space. The multiparty interface is a graphical interface that can be used to perform one or more iterations of entering inputs and submitting prompts to an AI model and receiving responses from the AI model. Multiple users enter inputs and submit prompts to an AI model via the multiparty interface.

In various embodiments, the intent management application analyzes the inputs of one or users to the multiparty interface. The intent management application determines whether the inputs are prompts that are to be submitted to an AI model. For example, the intent management application parses and analyzes the contents of a textual input to determine whether the input includes a textual prompt for an AI model and, if so, for a particular type of AI model. The intent management application collects and aggregates a plurality of prompts that have been generated by multiple users. In some embodiments, the intent management application applies weights to the individual prompts, such as by applying user weight values that have been designated to individual users. Alternatively, the intent management application can apply weight values to specific prompts. The intent management application generates a composite prompt based on the multiple prompts and the weight values.

The intent management application identifies one or more AI models that are trained to process the composite prompt. The intent management application inputs the composite prompt to the identified AI model. The AI model can be local or remote to the server device. The AI model, trained using histories of prompts, generated digital content items, and evaluations of the generated digital content items, generates a digital content item that is responsive to the composite prompt. In some embodiments, the AI model generates a digital content item usable in a design project. Alternatively, in some embodiments, the generative AI model generates a plurality of digital content items. Each of the generated digital content items adheres to the characteristics specified by the composite prompt. The intent management displays the one or more digital content items via the GUI in the multiparty interface, where the digital content item is selectable to be moved in a design space.

In some embodiments, the intent management application determines that at least one additional AI model is to generate a digital content item based on the composite prompt. In one example, the composite prompt is directed to a plurality of AI models of a similar type to generate alternative digital content items. In such instances, the intent management application inputs the composite prompt into each of the plurality of AI models. In some embodiments, the composite prompt causes the AI model to create a generative prompt that is directed to an additional AI model. In such instances, the intent management application receives the generative prompt created by the AI model and inputs the generative prompt to the additional AI model. The additional AI model generates a digital content item based on the generative prompt.

At least one technical advantage of the disclosed techniques relative to the prior art is that the disclosed techniques enable a CAD application to collect and aggregate inputs from multiple different users in a user group when generating prompts, which allows an AI system to understand the collective ideas and intents of the user group more accurately and generate digital content that more accurately reflects those collective ideas and intents. In that regard, the disclosed techniques provide an automated process for collecting a plurality of prompts generated from multiple users in a shared interface and weighing the different prompts before transmitting the prompts to the AI model for execution. Collecting and weighing multiple prompts used as inputs to the AI model enables group members to clarify the collective ideas and intents of the group by emphasizing specific ideas and goals. Accordingly, the disclosed techniques enable the AI model to better infer the ideas and intents of the group of users and generate digital content that is more reflective of those ideas and intents. Accordingly, the disclosed techniques enable a group of users to generate digital content using a CAD application that aligns better with the actual ideas and intents of the group without requiring coordination between group members using a separate communication channel. These technical advantages provide one or more technological advancements over prior art approaches.

1. In various embodiments, a computer-implemented method for generating digital content, the method comprising generating a multiparty interface that communicates with at least a trained machine learning (ML) model, a first client device, and a second client device, combining at least a first input from the first client device and a second input from the second client device to generate a composite prompt, transmitting the composite prompt to the trained ML model for execution, receiving a digital content item from the trained ML model that was generated in response to the composite prompt, and displaying the digital content item in the multiparty interface.

2. The computer-implemented method of clause 1, further comprising determining that the first input comprises at least one prompt for the trained ML model.

3. The computer-implemented method of clause 1 or 2, where determining that the first input comprises at least one prompt for the trained ML model comprises generating an input confidence score associated with the first input, and determining that the input confidence score exceeds a predetermined threshold.

4. The computer-implemented method of any of clauses 1-3, further comprising generating an output confidence score that indicates whether the digital content item is responsive to at least one of the first input or the second input.

5. The computer-implemented method of any of clauses 1-4, where combining at least the first input from the first client device and the second input from the second client device comprises applying a first weight value to the first input, and applying a second weight value to the second input.

6. The computer-implemented method of any of clauses 1-5, where the first weight value is designated to a first user of the first client device and the second weight value is designated to a second user of the second client device.

7. The computer-implemented method of any of clauses 1-6, further comprising receiving the first weight value for the first input via a graphical user interface (GUI), and receiving the second weight value for the second input via the GUI.

8. The computer-implemented method of any of clauses 1-7, where the digital content item comprises a generative prompt and further comprising executing a second trained ML model on the generative prompt to generate a second digital content item, and displaying the second digital content item in the multiparty interface.

9. The computer-implemented method of any of clauses 1-8, where the composite prompt includes at least an intent text and a non-textual input, and where the non-textual input comprises at least one of: a computer-aided design (CAD) object, a geometry, an image, a sketch, a video, an application state, or an audio recording.

10. The computer-implemented method of any of clauses 1-9, where the intent text is included in the first input, and the non-textual input is included in one or more non-textual inputs comprising the second input.

11. In various embodiments, one or more non-transitory computer-readable media include instructions that, when executed by one or more processors, cause the one or more processors to generate design content by performing the steps of generating a multiparty interface that communicates with at least a trained machine learning (ML) model, a first client device, and a second client device, combining at least a first input from the first client device and a second input from the second client device to generate a composite prompt, transmitting the composite prompt to the trained ML model for execution, receiving a digital content item from the trained ML model that was generated in response to the composite prompt, and displaying the digital content item in the multiparty interface.

12. The one or more non-transitory computer-readable media of clause 11, where a server device generates the multiparty interface and further comprising instructions that, when executed by the one or more processors, cause the one or more processors to perform the steps of transmitting, by the server device, the composite prompt to a remote device executing the trained ML model.

13. The one or more non-transitory computer-readable media of clause 11 or 12, where the digital content item comprises one of: a text, a computer-aided design (CAD) object, a geometry, an image, a sketch, a video, executable code, or an audio recording.

14. The one or more non-transitory computer-readable media of any of clauses 11-13, where combining at least the first input from the first client device and the second input from the second client device comprises applying a first weight value to the first input, and applying a second weight value to the second input.

15. The one or more non-transitory computer-readable media of any of clauses 11-14, further comprising instructions that, when executed by the one or more processors, cause the one or more processors to perform the steps of receiving the first weight value for the first input via a graphical user interface (GUI), and receiving the second weight value for the second input via the GUI.

16. The one or more non-transitory computer-readable media of clauses 11-15, where the digital content item comprises a generative prompt and further comprising instructions that, when executed by the one or more processors, cause the one or more processors to perform the steps of executing a second trained ML model on the generative prompt to generate a second digital content item, and displaying the second digital content item in the multiparty interface.

17. The one or more non-transitory computer-readable media of clauses 11-16, where the composite prompt includes at least an intent text and a non-textual input, and wherein the non-textual input comprises at least one of: a computer-aided design (CAD) object, a geometry, an image, a sketch, a video, an application state, or an audio recording.

18. The one or more non-transitory computer-readable media of clauses 11-17, where the trained ML model is trained using at least a combination of a first modality associated with text and at least one other modality associated with a non-textual input.

19. The one or more non-transitory computer-readable media of clauses 11-18, further comprising instructions that, when executed by the one or more processors, cause the one or more processors to perform the steps of executing a second trained ML model on the composite prompt to generate a second digital content item and displaying the second digital content item in the multiparty interface.

20. In various embodiments, a system comprises one or more memories storing instructions, and one or more processors coupled to the one or more memories that, when executing the instructions, perform the steps of generating a multiparty interface that communicates with at least a trained machine learning (ML) model, a first client device, and a second client device, combining at least a first input from the first client device and a second input from the second client device to generate a composite prompt, transmitting the composite prompt to the trained ML model for execution, receiving a digital content item from the trained ML model that was generated in response to the composite prompt, and displaying the digital content item in the multiparty interface.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more non-transitory computer readable medium or media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating digital content, the method comprising:
generating a multiparty interface that communicates with at least a trained machine learning (ML) model, a first client device, and a second client device;
combining at least a first input from the first client device and a second input from the second client device to generate a composite prompt;
transmitting the composite prompt to the trained ML model for execution;
receiving a digital content item from the trained ML model that was generated in response to the composite prompt; and
displaying the digital content item in the multiparty interface.

2. The computer-implemented method of claim 1, further comprising determining that the first input comprises at least one prompt for the trained ML model.

3. The computer-implemented method of claim 2, wherein determining that the first input comprises at least one prompt for the trained ML model comprises:
generating an input confidence score associated with the first input; and
determining that the input confidence score exceeds a predetermined threshold.

4. The computer-implemented method of claim 1, further comprising generating an output confidence score that indicates whether the digital content item is responsive to at least one of the first input or the second input.

5. The computer-implemented method of claim 1, wherein combining at least the first input from the first client device and the second input from the second client device comprises:
applying a first weight value to the first input; and
applying a second weight value to the second input.

6. The computer-implemented method of claim 5, wherein the first weight value is designated to a first user of the first client device and the second weight value is designated to a second user of the second client device.

7. The computer-implemented method of claim 5, further comprising:
receiving the first weight value for the first input via a graphical user interface (GUI); and
receiving the second weight value for the second input via the GUI.

8. The computer-implemented method of claim 1, wherein the digital content item comprises a generative prompt and further comprising:
executing a second trained ML model on the generative prompt to generate a second digital content item; and
displaying the second digital content item in the multiparty interface.

9. The computer-implemented method of claim 1, wherein the composite prompt includes at least an intent text and a non-textual input, and wherein the non-textual input comprises at least one of: a computer-aided design (CAD) object, a geometry, an image, a sketch, a video, an application state, or an audio recording.

10. The computer-implemented method of claim 9, wherein the intent text is included in the first input, and the non-textual input is included in one or more non-textual inputs comprising the second input.

11. One or more non-transitory computer-readable media including instructions that, when executed by one or more processors, cause the one or more processors to generate design content by performing the steps of:
generating a multiparty interface that communicates with at least a trained machine learning (ML) model, a first client device, and a second client device;
combining at least a first input from the first client device and a second input from the second client device to generate a composite prompt;
transmitting the composite prompt to the trained ML model for execution;
receiving a digital content item from the trained ML model that was generated in response to the composite prompt; and
displaying the digital content item in the multiparty interface.

12. The one or more non-transitory computer-readable media of claim 11, wherein a server device generates the multiparty interface and further comprising instructions that, when executed by the one or more processors, cause the one or more processors to perform the steps of transmitting, by the server device, the composite prompt to a remote device executing the trained ML model.

13. The one or more non-transitory computer-readable media of claim 11, wherein the digital content item comprises one of: a text, a computer-aided design (CAD) object, a geometry, an image, a sketch, a video, executable code, or an audio recording.

14. The one or more non-transitory computer-readable media of claim 11, wherein combining at least the first input from the first client device and the second input from the second client device comprises:
applying a first weight value to the first input; and
applying a second weight value to the second input.

15. The one or more non-transitory computer-readable media of claim 14, further comprising instructions that, when executed by the one or more processors, cause the one or more processors to perform the steps of:
receiving the first weight value for the first input via a graphical user interface (GUI); and
receiving the second weight value for the second input via the GUI.

16. The one or more non-transitory computer-readable media of claim 11, wherein the digital content item comprises a generative prompt and further comprising instructions that, when executed by the one or more processors, cause the one or more processors to perform the steps of:
executing a second trained ML model on the generative prompt to generate a second digital content item; and
displaying the second digital content item in the multiparty interface.

17. The one or more non-transitory computer-readable media of claim 11, wherein the composite prompt includes at least an intent text and a non-textual input, and wherein the non-textual input comprises at least one of: a computer-aided design (CAD) object, a geometry, an image, a sketch, a video, an application state, or an audio recording.

18. The one or more non-transitory computer-readable media of claim 11, wherein the trained ML model is trained using at least a combination of a first modality associated with text and at least one other modality associated with a non-textual input.

19. The one or more non-transitory computer-readable media of claim 11, further comprising instructions that, when executed by the one or more processors, cause the one or more processors to perform the steps of:
executing a second trained ML model on the composite prompt to generate a second digital content item; and
displaying the second digital content item in the multiparty interface.

20. A system comprising:
one or more memories storing instructions; and
one or more processors coupled to the one or more memories that, when executing the instructions, perform the steps of:
generating a multiparty interface that communicates with at least a trained machine learning (ML) model, a first client device, and a second client device;
combining at least a first input from the first client device and a second input from the second client device to generate a composite prompt;
transmitting the composite prompt to the trained ML model for execution;
receiving a digital content item from the trained ML model that was generated in response to the composite prompt; and
displaying the digital content item in the multiparty interface.
